(19) United States
(12) Patent Application Publication
(10) Pub. No.: US 2023/0001428 A1
(43) Pub. Date: Jan. 5, 2023

(54) MULTIFUNCTIONAL AIR POLLUTION REDUCTION DEVICE

(71) Applicants: NATIONAL CHENG KUNG UNIVERSITY, Tainan City (TW); Southern Taiwan University of Science and Technology, Tainan City (TW); National Sun Yat-sen University, Kaohsiung City (TW)

(72) Inventors: Ming-Yeng LIN, Tainan City (TW); Yung-Chung CHEN, Tainan City (TW); Huann-Shyang LIN, Kaohsiung City (TW); Chun-Juei CHOU, Tainan City (TW); Sheng-He WANG, Tainan City (TW)

(21) Appl. No.: 17/857,292

(22) Filed: Jul. 5, 2022

Related U.S. Application Data
(60) Provisional application No. 63/218,404, filed on Jul. 5, 2021.

(51) Int. Cl. B03C 3/41; B03C 3/06; B01D 53/86

(52) U.S. Cl. CPC B03C 3/41; B03C 3/06; B01D 53/86; A61C 1/10

(57) ABSTRACT

A multifunctional air pollution reduction device includes a tool and a multifunctional pollutant remover. The multifunctional pollutant remover is adjacent to or integrated with the tool. The multifunctional pollutant remover can not only reduce air pollution, but also help reduce one or more of the following problems when using the tools: noise, vibration and/or slip.

### CROSS REFERENCE TO RELATED APPLICATION

This application claims the benefit of filing date of U.S. Provisional Application Ser. No. 63/218,404, entitled “MULTIFUNCTIONAL AIR POLLUTION REDUCTION DEVICE” filed Jul. 5, 2021 under 35 USC § 119(e)(1).

### BACKGROUND

### 1. Field of the Disclosure

The present invention relates to a multifunctional air pollution reduction device that can be used for tools such as dental handpieces, ultrasonic dental scalars, ultrasonic dental scaling tips, electrosurgical pencils and/or polishing tools.

### 2. Description of Related Art

When using a tool to process a material, air pollution often occurs, and the user may inhale air pollutants which can cause cardiovascular or respiratory diseases. In addition, noise is often generated during an operating of the tool; the noise may lead to hearing loss. Finally, vibration may also occur when using the tool, causing diseases such as Hand-Ann Vibration Syndrome (HAVS).

In the case of dental service, a dentist, a dental hygienist, and a technician use dental handpieces. However, when using a dental handpiece to treat patients or process materials, a large amount of air pollution may be generated. The air pollutant contains hazardous materials such as ultrafine particles, PM_{2.5}, PM₁₀, aerosols, sprays, mists, droplets, bio-aerosols, gases, and volatile organic compounds (VOCs). These kinds of air pollutant can affect both the patient and dental personnel in an operation room. Some studies show that dental technicians are at risk of respiratory diseases.

Another problem of the dental handpiece and the ultrasonic scaling tip is noise pollution. Some studies report that dentists face a risk of hearing problems during work. Furthermore, the noise from a dental handpiece or dental drill can also cause anxiety and discomfort to a patient.

Using dental handpieces may also lead to vibration related diseases, including musculosketal disorder, small fiber nerve or mechanorecptory injury. Another study shows that people using dental handpieces are at higher risk of finger-related symptoms and upper limb symptoms.

However, there still lacks effective methods to reduce such vibration in dental handpieces and ultrasonic scaling tips. Thus, air pollution, noise, and vibration is needed to be reduced in order to protect dental personnel.

Some of the dental service provider use local exhaust ventilation (LEV) to remove the air pollutants. However, most of the current local exhaust ventilations are standalone devices that occupy much space. Some local exhaust ventilation even require another person to hold it.

Recently, some patents (e.g. U.S. patent application Ser. No. 16/212,758) attach an ionizer and/or a local exhaust ventilation to a tool such as a dental handpiece or an electrosurgical pencil to reduce air pollution. However, the device can still not reduce the noise and the vibration produced from dental handpiece. Moreover, the electric wire of the ionizer that is attached to the outside the dental handpiece can make it uncomfortable to hold. Therefore, it is desirable to provide an improved device that can reduce the noise, the vibration and grip discomfort in addition to air pollution from the tools such as the dental handpieces or the ultrasonic scaling tips.

In a case in an operation room, surgical smoke is produced when using an electrosurgical pencil during surgery. Surgical smoke contains hazardous gases and particles (aerosols). Exposure to surgical smoke can be hazardous to health. Although using the electrosurgical pencil will not generate noise and vibration, the electrosurgical pencil may be slippery when contacting with body fluid during the surgical process, and may affect the surgery. In addition, this kind of slippery problem can also happen during operation of dental tools. It is noted that the aforementioned U.S. application Ser. No. 16/212,758 does not have an anti-slip function. Thus, it is also desirable for the improved device to have anti-slip function.

### SUMMARY OF THE INVENTION

The objective of the present invention is to provide a multifunctional air pollution reduction device for reducing air pollution generated during an operation of tools.

To achieve the objective, a multifunctional air pollution reduction device is designed to include a tool, and a multifunctional pollutant remover. The multifunctional pollutant remover is disposed adjacent to or integrated with the tool. If the multifunctional pollutant remover is disposed adjacent to the tool, the multifunctional pollutant remover is a removable device that is attachable to and removable from the tool. The multifunctional air pollution reduction device cannot only reduce air pollution, but is also helpful to reduce one or more of the following problems such as noise, vibration, gripping discomfort, and slippage problems when using the tools.

Optionally or preferably, the tool is a hand-held tool.

Optionally or preferably, the tool is a machine-held tool.

Optionally or preferably, the tool is a low-speed or high-speed dental handpiece.

Optionally or preferably, the multifunctional air pollution reduction device includes an ionizer that emits positively or negatively charged ions to enhance deposition of the air pollutants and reduce air pollution concentration.

Optionally or preferably, the multifunctional air pollution reduction device is connected to a vacuum pump that sucks the air pollutants out.

Optionally or preferably, the multifunctional air pollution reduction device includes a deposition surface that carries charges to enhance particle deposition.

Optionally or preferably, the multifunctional air pollution reduction device is connected to a phtocatalytic air purifier or a photocatalytic oxidation air purifier that generates reactive oxygen species (ROS), which can react with air pollutants and form CO₂ and H₂O.

Optionally or preferably, the multifunctional air pollution reduction device includes a passive vibration control piece that uses a spring and/or a damper to reduce vibration.

Optionally or preferably, the multifunctional air pollution reduction device includes an active vibration control device that uses a control system with integrated a sensor and an actuator to reduce vibration.

Optionally or preferably, the multifunctional air pollution reduction device for includes a power supply connected to the tool and/or the multifunctional air pollution reduction device.

Optionally or preferably, the multifunctional air pollution reduction device includes a sensor to monitor the operation of the tools and send a signal to the controller.

Optionally or preferably, the multifunctional air pollution reduction device includes a controller that turns on/off the multifunctional pollutant remover and/or the tools.

### BRIEF DESCRIPTION OF THE DRAWINGS

FIG. 1 is a schematic diagram illustrating the structure of the multifunctional air pollution reduction device according to a first embodiment of the present invention;

FIG. 2 is a schematic diagram illustrating the structure of a multifunctional air pollution reduction device according to a second embodiment of the present invention;

FIG. 2A is an enlarged view illustrating the outlet nozzle of the multifunctional air pollution reduction device according to the second embodiment of the present invention;

FIG. 2B is a schematic diagram illustrating a multifunctional air pollution reduction device and an air source according to the second embodiment of the present invention;

FIG. 2C is a schematic diagram illustrating a multifunctional air pollution reduction device and a vacuum pump according to the second embodiment of the present invention;

FIG. 2D is a schematic diagram illustrating the structure of a multifunctional air pollution reduction device according to a variant of the second embodiment of the present invention;

FIG. 3 is a schematic diagram illustrating the structure of a multifunctional air pollution reduction device according to a third embodiment of the present invention;

FIG. 3A is a schematic diagram illustrating the operation of a multifunctional air pollution reduction device according to a third embodiment of the present invention;

FIG. 3B is another schematic diagram illustrating the structure of a multifunctional air pollution reduction device according to a third embodiment of the present invention;

FIG. 4 is a schematic diagram illustrating the structure of a multifunctional air pollution reduction device according to the fourth embodiment of the present invention;

FIG. 4A is an enlarged view illustrating a portion of the active vibration control device of the multifunctional air pollution reduction device according to the fourth embodiment of the present invention;

FIG. 5 is a schematic diagram illustrating the structure of a multifunctional air pollution reduction device according to the fifth embodiment of the present invention;

FIG. 6 is a schematic diagram illustrating the structure of a multifunctional pollutant remover according to the sixth embodiment of the present invention;

FIG. 6A is another schematic diagram illustrating the structure of a multifunctional pollutant remover according to the sixth embodiment of the present invention; and

FIG. 6B is a schematic diagram illustrating the structure of a multifunctional air pollution reduction device according to the sixth embodiment of the present invention.

### DETAILED DESCRIPTION OF EMBODIMENT

The implementation of the present disclosure is illustrated by specific embodiments to enable persons skilled in the art to easily understand the other advantages and effects of the present disclosure by referring to the disclosure contained therein. The present disclosure is implemented or applied by other different, specific embodiments. Various modifications and changes can be made in accordance with different viewpoints and applications to details disclosed herein without departing from the spirit of the present disclosure.

It should be noted that, in the specification and claims, unless otherwise specified, having “one” element is not limited to having a single said element, but one or more said elements may be provided.

In addition, the term “adjacent” used in the specification and claims may refer to describe mutual proximity and does not necessarily mean mutual contact.

In addition, the description of “when . . . ” or “while. . .” in the present disclosure means “now, before, or after”, etc., and is not limited to occurrence at the same time. In the present disclosure, the similar description of “disposed on” or the like refers to the corresponding positional relationship between the two components, and does not limit whether there is contact between the two components, unless specifically limited. Furthermore, when the present disclosure recites multiple effects, if the word “or” is used between the effects, it means that the effects can exist independently, but it does not exclude that multiple effects can exist at the same time.

In addition, the terms “connect” in the specification and claims not only refer to direct connection with another component, but also indirect connection with another component, or refer to electrical connection. Besides, the electrical connection may include a direct connection, an indirect connection, or a mode in which two components communicate through radio signals.

In addition, in the specification and claims, the term “almost”, “about”, “approximately” or “substantially” usually means within 20%, 10%, 5%, 3%, 2%, % or 0.5% of a given value or range. The quantity the given value is an approximate quantity, which means that the meaning of “almost”, “about”, “approximately” or “substantially” may still be implied in the absence of a specific description of “almost”, “about”, “approximately” or “substantially”. In addition, the terms “ranging from the first value to the second value” and “range between the first value to the second value” indicate that the range includes the first value, the second value, and other values between the first value and the second value.

In addition, in this disclosure, the term such as “system”, “apparatus”, “device”, “module” or “unit” refers to an electronic component or a digital circuit composed of multiple electronic components, an analog circuit, or other more generalized circuits, and unless otherwise specified, they do not necessarily have a hierarchical relationship. In addition, each component may be implemented as a single circuit or an integrated circuit in a suitable manner, and may include one or more active components, such as transistors or logic gates, or one or more passive components, such as resistor, capacitor or inductor, but not limited thereto. The components may be connected to each other in a suitable manner, for example, respectively matching the input signal and the output signal, and using one or more lines to form a series or parallel connection. Besides, each component may allow input and output signals to enter and exit sequentially or in parallel. The aforementioned configurations are determined according to the actual application.

In addition, the technical features of the different embodiments disclosed in this disclosure may be split or combined to form another embodiment.

Some embodiments are provided in the following description for the purpose of illustrating the present invention. The features and the function of one embodiment may be applied to other embodiments by variation, modification, separation, selection, combination, or transformation in a suitable manner.

A figure may show essential elements and optimal or preferable element of one embodiment. In other words, it does not mean that all elements in the figure are essential elements of the embodiment.

### First Embodiment

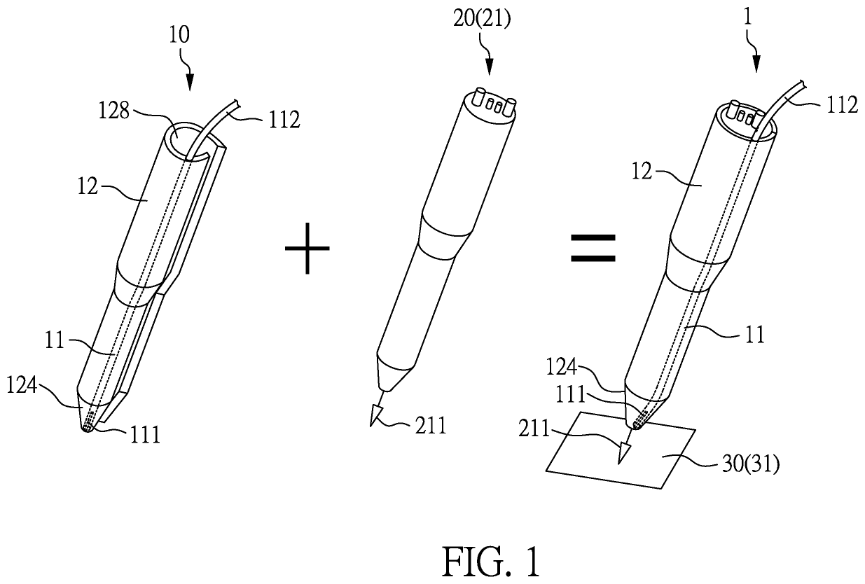

FIG. 1 is a schematic diagram illustrating the structure of a multifunctional air pollution reduction device 1 according to a first embodiment of the present invention.

In this embodiment, the multifunctional air pollution reduction device 1 is a dental apparatus. However, in other embodiments, it may be an apparatus used for polishing nails or jewelry, and is not limited thereto.

In the first embodiment, the multifunctional air pollution reduction device 1 includes a multifunctional pollutant remover 10 and a tool 20. The multifunctional pollutant remover 10 can be attached to the tool 20 to form the multifunctional air pollution reduction device 1. The multifunctional pollutant remover 10 herein is a removable device that can be easily attached to and removed from the tool 20. Optionally, the tool 20 may be a hand-held tool or a machine-held tool. The tool 20 herein is an air driven handpiece 21 which can be used in dentistry. Air pollution is generated when using the air driven handpiece on a tooth or process other materials. In other embodiments, the tool 20 may be a dental handpiece, an air driven handpice, an electric handpiece, an ultrasonic dental scalar, an ultrasonic dental scaling tip, an electrosurgical pencil, a polishing tool, or a tool that generates air pollution and/or noise and/or vibration during the operation.

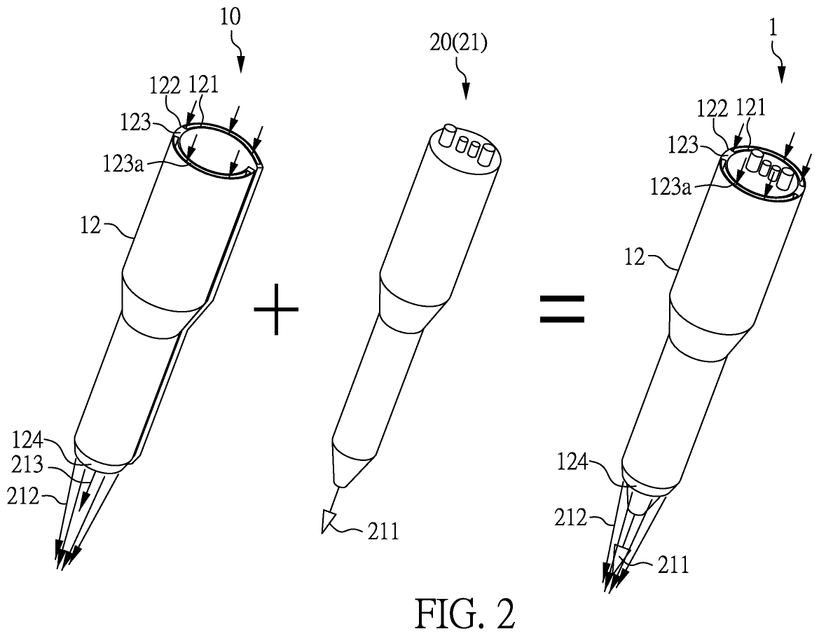

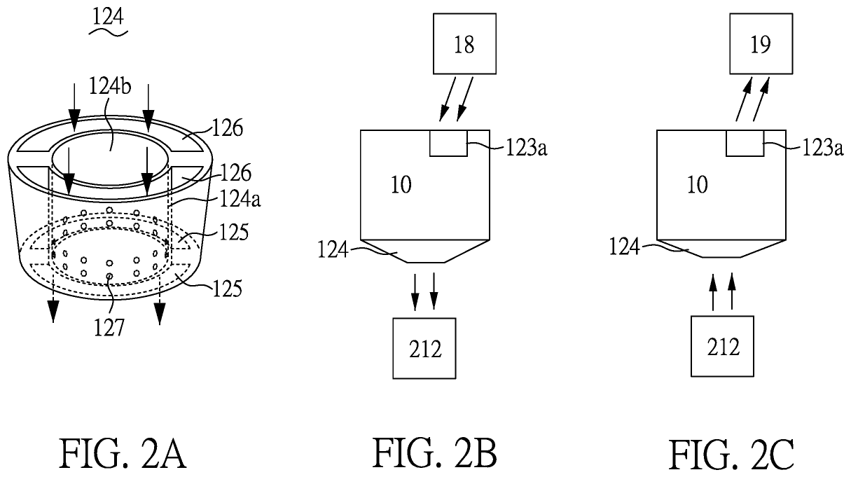

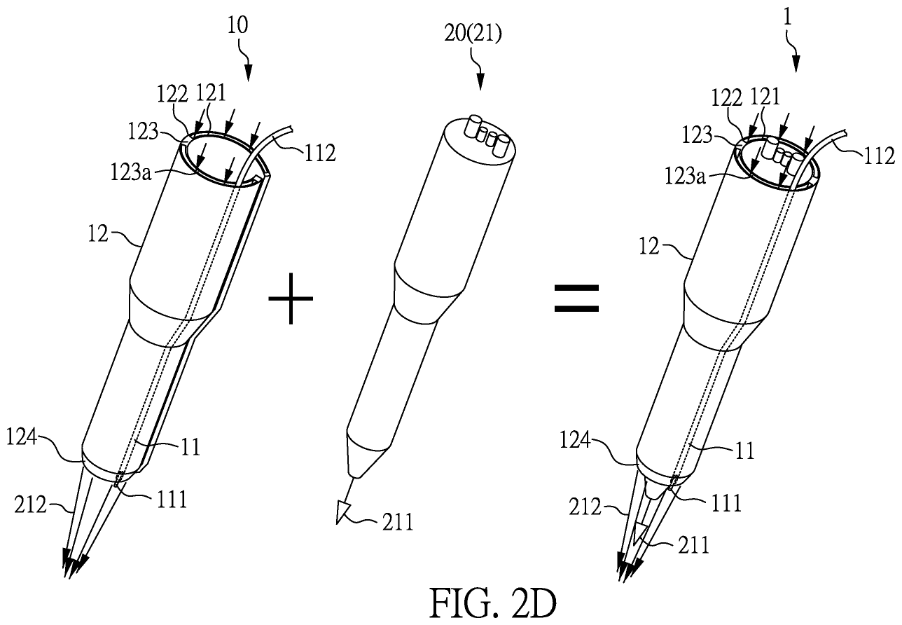

The multifunctional pollutant remover 10 includes an ionizer 11 and a rubber-like material part 12 that is located adjacent to the tool 20, wherein material of the rubber-like material part 12 may be rubber and/or rubber-like material. The ionizer 11 includes a tip 111 and a wire 112, wherein the tip 111 is adjacent to an outlet nozzle 124. The air driven handpiece 21 includes a bur 211. When the multifunctional pollutant remover 10 is combined with the tool 20, the ionizer 11 nears the bur 211 of the air driven handpiece 21 and releases the ions. The ionizer 11 can emit high concentration of positive and/or negative ions through the tip 111, and can enhance the deposition of air pollutants, thereby reducing the concentration of the air pollutants, and thus reducing the air pollution. The ionizer 11 is connected to the power through the wire 112. Optionally, the multifunctional air pollution reduction device 1 further includes a charged deposition surface 30, wherein the charged deposition surface 30 in this case is, but not limited to, an electret filter 31 that is placed under the multifunctional pollutant remover 10 to further increase the removal efficiency of air pollutants. Optionally, the rubber-like material part 12 has an empty center 128 to contain the tool 20. Optionally, the rubber-like material part 12 has a thickness having a contain space (e.g. a space 123a in FIG. 2), and the ionizer 11 can be disposed in the contain space, and/or airflow can pass through the contain space, but not limited thereto.

The rubber-like material part 12 is located at the position where is suitable for the user to hold the air driven handpiece 21. Optionally, the rubber-like material part 12 includes an anti-slip and/or anti-vibration surface to reduce slipping and/or vibration when the user holds the air driven handpiece 21, so as to ease the handling of the tool 20.

Optionally or preferably, the rubber-like material part 12 can fully or partially cover the air driven handpiece 21. Optionally, the rubber-like material part 12 can fully or partially enclose the wire of the ionizer to reduce hand slipping, improve grip, reduce noise and/or vibration, and make the handling of the tool even more comfortable.

Thus, the first embodiment of the multifunctional air pollution reduction device for tools 1 can be realized.

### Second Embodiment

FIG. 2 is a schematic diagram illustrating the structure of the multifunctional air pollution reduction device 1 according to a second embodiment of the present invention. FIG. 2A is an enlarged view illustrating the outlet nozzle 124 of the multifunctional air pollution reduction device 1 according to the second embodiment of the present invention.

The second embodiment is similar to the first embodiment, and the multifunctional air pollution reduction device 1 also includes the multifunctional pollutant remover 10 and the tools 20, wherein the multifunctional pollutant remover 10 can be easily attached to and removed from the tool 20. The tool 20 is an air driven handpiece 21 that can be used in dentistry. However, the multifunctional pollutant remover is different from the first embodiment. The multifunctional pollutant remover 10 in this case surrounds the air driven handpiece 21 and has the rubber-like material part 12 having an inner layer 121, an outer layer 122, at least a support 123 (e.g. one or more supports 123) and an outlet nozzle 124. The supports 123 are between the inner layer 121 and outer layer 122 for supporting the inner layer 121 and the outer layer 122, so as to prevent crushing of the two layers. In addition, there is also a space 123a between the inner layer 121 and outer layer 122 to let air pass through and blow toward the outlet nozzle 124.

Optionally, as shown in FIGS. 2 and 2A, the outlet nozzle 124 has at least a wide air inlet (e.g. the holes 126) and at least a narrow air outlet (e.g. the holes 125) to accelerate the air exiting from the outlet nozzle 124 to form an air curtain 212. Air curtain 212 can be conical shaped. Air curtain 212 can contain air pollutants, water, and/or water spray mist within the air curtain. Thus, reducing the spread of the air pollutants, water spray mist, water and/or water spray to the surrounding area. Optionally or preferably, the outlet nozzle 124 has inner surface 124a forming a hollow part 124b, and there are one or more small holes 127 formed on the inner surface 124a, wherein the holes 127 are adjacent to the holes 125, so as to let a part of the air enter and exit to form a downward suppression air 213 within the air curtain 212. The downward suppression air 213 can press down water, spray mist, and/or aerosol within the air curtain 212; this can give the dental personnel a clear view. The inner layer 121 and outer layer 122 are made of rubber-like material that can help reduce the noise and the vibration amplitude from the air driven handpiece 21. Optionally, the shape of the air curtain 212 can also be cylindrical or any shape that helps confine the air pollutants.

Optionally, the outlet nozzle 124 can be replaced by flanges or a simple air outlet design without using the nozzle outlet.

Optionally, only the inner layer 121 is made of rubber-like material to help reduce the noise and vibration level. The outer layer 122 can be made from other materials, such as polymers, biomaterials, synthetic materials, but not limited thereto.

FIG. 2B is a schematic diagram illustrating the multifunctional air pollution reduction device 1 and an air source 18 according to the second embodiment of the present invention. Optionally, the multifunctional pollutant remover 10 is connected with an air source 18 for providing air to the multifunctional pollutant remover 10, wherein the air source 18 can be a photocatalytic air purifier or a photocatalytic oxidation air purifier, but not limited thereto. Furthermore, the photocatalytic air purifier or the photocatalytic oxidation air purifier generates airflow towards the bur 211. Optionally, the airflow generated by the air source 18 can pass through the space 123a between the inner layer 121 and the outer layer 122. Furthermore, in an embodiment, the airflow generated by the air source 18 can be delivered into the multifunctional pollutant remover 10 through a delivery conduit connected to the multifunctional pollutant remover 10, wherein the shape of the delivery conduit can be cylindrical or flat, and is not limited thereto. In an embodiment, when the airflow generated by the air source 18 passes through the empty center 128 of the rubber-like material part 12, the delivery conduit can be integrated with the tool 20, e.g. the delivery conduit can only have a semicircular structure and be connected to the housing of the tool 20, so that the airflow generated by the air source 18 can be delivered in an enclosed space formed by the semicircular structure and the housing 20 of the tool 20. Optionally, the airflow generated by the air source 18 can react with the microorganisms or organic compounds within the air pollutant to form CO₂ and H₂O. Optionally, the component of the supplied air from the air source can comprises: particle free air, compress air, positive or negative ions, reactive oxygen species (ROS), gas, particles or water vapor, or any combination above, but not limited thereto. Optionally, a part of the air provided by the air source 18 can form the air curtain 212, but not limited thereto.

FIG. 2C is a schematic diagram illustrating the multifunctional air pollution reduction device 1 and an vacuum pump 19 according to the second embodiment of the present invention. As shown in FIG. 2C, the multifunctional pollutant remover 10 is connected to a vacuum pump 19 for sucking the pollutants from the pollution source (e.g. the position of the bur 211), wherein the airflow carrying the pollutants is away from the bur 211, and flows to vacuum pump 19 through the space 123a. Optionally, the operation time of the air source 18 and the operation time of the vacuum pump 19 are not overlapped.

FIG. 2D is a schematic diagram illustrating the structure of a multifunctional air pollution reduction device 1 according to a variant of the second embodiment of the present invention. The embodiment of FIG. 2D can be regarded as a feature combination of the first embodiment shown in FIG. 1 and the second embodiment shown in FIG. 2. As shown in FIG. 2D, the multifunctional pollutant remover 10 further includes the ionizer 11 described in the embodiment of FIG. 1. Optionally, the ionizer 11 is adjacent to the tool 20, and a release point of the ionizer 11 is within the air curtain 212, or ionizer 11 releases ions inside and/or outside of the air curtain 212, so as to help remove the air pollutants in the air curtain 212.

Optionally, the ionizer 1I can be located in the space 123a or the empty center 128, but not limited thereto.

Besides, in an embodiment, the multifunctional pollutant remover 10 of FIG. 2 or 2D is hard material (e.g., hard plastic or metals, and is not limited thereto) or soft material (e.g., rubber material or rubber-like material, and is not limited thereto). In an embodiment, the outer part of the multifunctional pollutant remover 10 is soft material suitable for holding, and the inner part of the multifunctional pollutant remover 10 is hard material allowing fewer supports 123, but not limited thereto.

Thus, the second embodiment can be realized.

### Third Embodiment

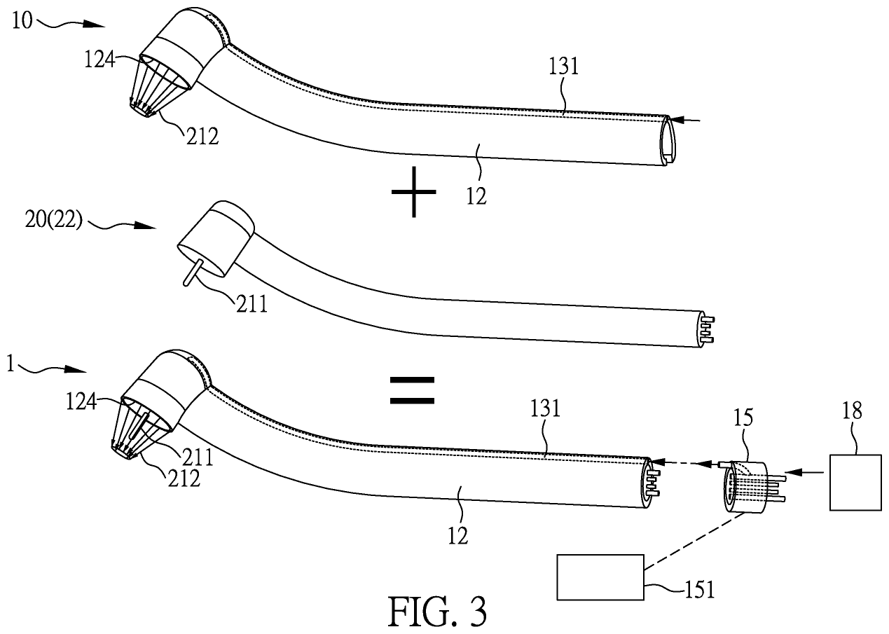

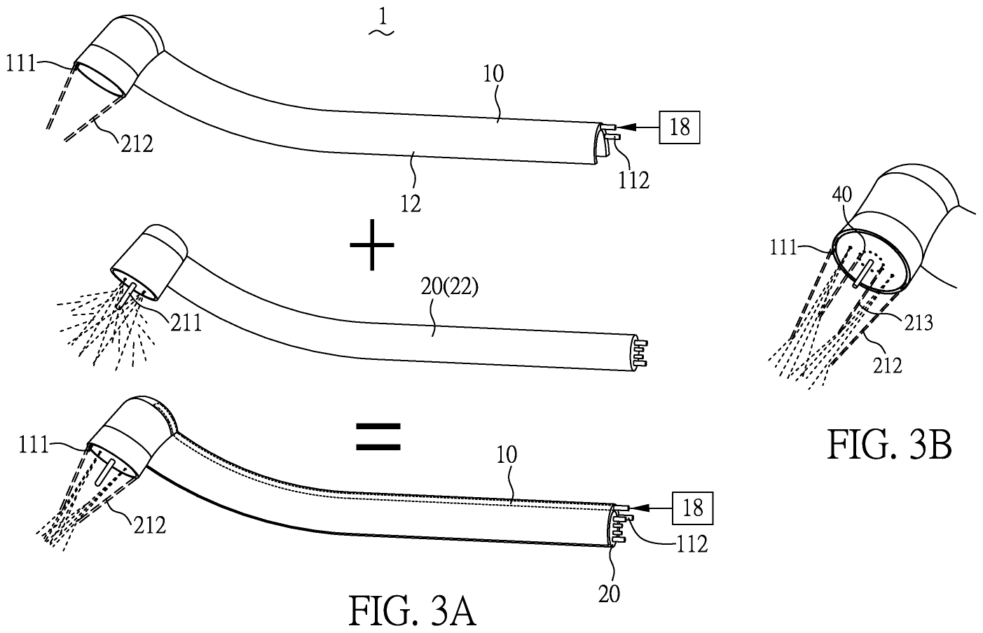

FIG. 3 is a schematic diagram illustrating the structure of the multifunctional air pollution reduction device 1 according to a third embodiment of the present invention. Some features of the third embodiment can be known from the content of the first embodiment and the second embodiment.

The multifunctional air pollution reduction device 1 of the third embodiment includes the multifunctional pollutant remover 10 and the tools 20.

The multifunctional pollutant remover 10 can be easily attached to or removed from the tool 20, which is a dental handpiece 22 which can be used in dentistry in this embodiment.

The multifunctional pollutant remover 10 includes a tube 131, the rubber-like material part 12 enclosing the dental handpiece 22, and an adapter 15. The rubber-like material part 12 has the outlet nozzle 124. The detail of the rubber-like material part 12 can be known from the contents of the first embodiment and the second embodiment, so that a detailed description is deemed unnecessary. The adapter 15 is used to connect the multifunctional air pollution reduction device 1 to a power supply 151 which is often located in a dental chair. The tube 131 is connected to an air source 18, so as to supply air towards the outlet nozzle 124. The air exiting the outlet nozzle 124 can form a cone shape (or other shape) air curtain 212 to confine the air pollutants, especially the large droplets, water spray mist, water and/or spray created by the dental handpiece 22. The detail of the air curtain 212 can be known from the contents of the first embodiment and the second embodiment, so that a detailed description is deemed unnecessary. Optionally, the air provided by from the tube 131 can pass through the space between the inner wall of the multifunctional pollutant remover 10 and the outer wall of the dental handpiece 22 to enter the outlet nozzle 124, and is not limited thereto.

Optionally, the tube 131 can be located in the space 123a (as shown in FIG. 2) or the empty center 128 (as shown in FIG. 2).

Optionally, the outlet nozzle 124 can be replaced by a vane or a simple air outlet design without using the nozzle outlet design.

Optionally, the dental handpiece 22 is but not limited to an electric dental handpiece.

Optionally or preferably, the supplied air exiting from the outlet nozzle 124 can form an air curtain 212 with any other shape, e.g. cylindrical, cone shape or any shape to help confine the air pollutants.

Optionally or preferably, the supplied air exiting from the outlet nozzle 124 contains negative or positive ions to reduce the air pollutants within the air curtain 212. Positive or negative ions can be generated from an ionizer 11 (not shown). The detail of the ionizer 11 can be known from the contents of the first embodiment and the second embodiment.

Optionally or preferably, the supplied air exiting from the outlet nozzle 124 contains reactive oxygen species (ROS) that can break down air pollutants into CO₂ and H₂O. ROS can be generated from a photocatalytic oxidation air purifier. The detail of the photocatalytic oxidation air purifier can be known from the contents of the first embodiment and the second embodiment.

The rubber-like material part 12 can make the multifunctional air pollution reduction device 1 more comfortable and ergonomic for the user. It also reduces the noise and vibration of the dental handpiece 22.

FIG. 3A is a schematic diagram illustrating the operation of the multifunctional air pollution reduction device 1 according to a third embodiment of the present invention. As shown in FIG. 3A, when the dental handpiece 22 is not combined with the multifunctional pollutant remover 10, large droplets or aerosols are generated and spread to the surrounding environment when the dental handpiece 22 is in operation. In addition, the multifunctional pollutant remover 10 generates air curtains 212 and negative ions (or positive ions) when the multifunctional pollutant remover 10 is in operation. When the dental handpiece 22 is combined with the multifunctional pollutant remover 10, the droplets or aerosols generated by the dental handpiece 22 can be blocked within the air curtains 212, and the negative ions (or positive ions) can help reduce the air pollutant concentration within the air curtain 212.

Besides, FIG. 3B is another schematic diagram illustrating the structure of a multifunctional air pollution reduction device 1 according to a third embodiment of the present invention. As shown in FIG. 3B, a plurality of air holes 40 are disposed around the bur 211 of the dental handpiece 22. The air holes 40 can provide the downward suppression air 213 to press down water, spray mist, and/or aerosol within the air curtain 212; so that dental personnel can have a clear view of the bur 211 when using the dental handpiece 22. In an embodiment, the air holes 40 disposed on the dental handpiece 22, and the downward suppression air 213 is provided from the dental handpiece 22. In another embodiment, the air holes 40 can be connected with the space 123a through a tube, so that the downward suppression air 213 is provided from the space 123a. Thus, the third embodiment can be realized.

### Fourth Embodiment

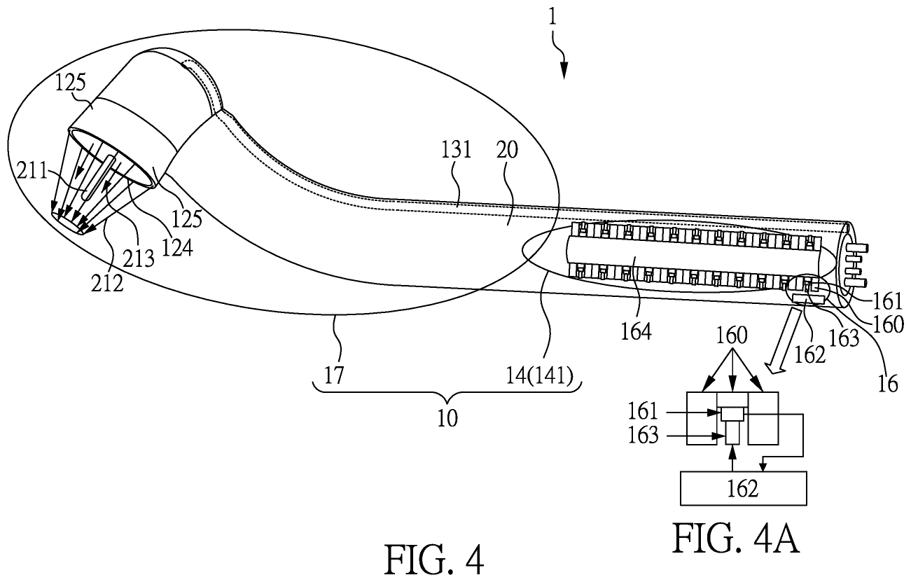

FIG. 4 is a schematic diagram illustrating the structure of a multifunctional air pollution reduction device 1 according to a fourth embodiment of the present invention. FIG. 4A is an enlarged view illustrating a portion of the active vibration control device 141 of the multifunctional air pollution reduction device 1 according to the fourth embodiment of the present invention.

In this embodiment, the multifunctional pollutant remover 10 is integrated with the tool 20, e.g. the multifunctional pollutant remover 10 is located in the tool 20. The tool 20 may be a dental handpiece 22 which can be used in dentistry. The multifunctional pollutant remover 10 contains two parts, the first part is the air pollution reduction device 17 provides an airflow that can blow air towards the bur 211. Notice the airflow exiting from the outlet nozzle 124 blown towards the bur 211 forms a cone shape (or other shape) air curtain 212 to help contain air pollutants such as larger droplet from exiting the tool 20 and polluting the surrounding area and people. There is also one or more small holes (e.g. the holes 127 shown in FIG. 2A) in the outlet nozzle 124, so as to let a proportion of the air enter to and exit from the outlet nozzle 124 to form a downward suppression air 213 within the air curtain 212, this can help clarify the view for the dental personnel.

The second part of the multifunctional pollutant remover 10 is a noise and vibration reduction device 14, e.g. an active vibration control device 141. The active vibration control device 141 includes a plurality of vibration control units 16, and each of the vibration control units 16 includes an elastomer 160, a sensor 161 and an actuator 163, and can be controlled by a controller 162. The elastomer 160, the sensor 161 and the actuator 163 may be integrated. The vibration control units 16 may be disposed adjacent to a motor 154 of the tool 20 or connected to the motor 154. Optionally, the vibration control units 16 are arranged in a direction. The vibration control units 16 of the active vibration control device 141 is shown in FIG. 4A. As shown in FIG. 4 and FIG. 4A, the sensor 161 detects the vibration and/or action of the motor 164 and sends a signal to the controller 162. The controller 162 generates a response signal according to the vibration and/or action of the motor 164, and sends the response signal to the actuator 163 to regulate the vibration of the motor 164, e.g. reduce the vibration of the motor 164.

Optionally, the active vibration control device 141 can be disposed on the inner surface of the multifunctional pollutant remover 10, and when the multifunctional pollutant remover 10 is combined with the tool 20, the position of the active vibration control device 141 is adjacent to the position of the motor 164.

Optionally, the outlet nozzle 124 can be replaced by a vane or a simple air outlet design without using the nozzle outlet design.

Optionally, the active vibration control device 141 may be replaced by a rubber-like material layer. The rubber-like material layer may fully or partially cover the motor 164 to reduce the noise and vibration. Besides, the noise and vibration reduction device 14 may include the active vibration control device 141 and the rubber-like material layer, e.g. the rubber-like material layer may be disposed on the outside of the active vibration control device 141, but not limited thereto.

Optionally, the active vibration control device 141 may also be replaced by a passive vibration control device (not shown). The passive vibration control device may include a spring and/or a damper, and uses the natural properties of the spring and/or the damper to reduce the vibration, e.g. the motor 164 or the tool 20 may be connected with the damper through the spring, but not limited thereto. Optionally, the noise and vibration reduction device 14 may include the active vibration control device 141 and the passive vibration control device. Optionally, the active vibration control device 141 and/or the passive vibration control device may be disposed in the tool 20, but may be disposed outside the tool 20 (e.g. connected to the rubber-like material part 12 of the multifunctional pollutant remover 10.)

Optionally, the controller 162 is configured to be controlled by a computer, a tablet, a plate panel, a smart phone, a remote controller, and/or Internet of things (IOT), but not limited thereto. Optionally, the controller 162 is a control chip, but not limited thereto.

Optionally, the dental handpiece can be air driven handpiece 21 or electric handpiece, but not limited thereto.

Thus, the fourth embodiment can be realized.

### Fifth Embodiment

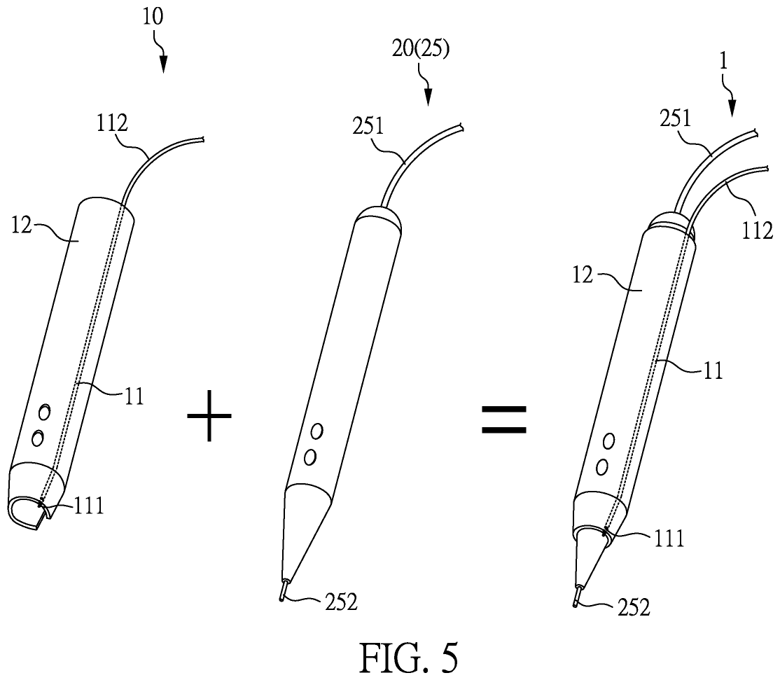

FIG. 5 is a schematic diagram illustrating the structure of a multifunctional air pollution reduction device 1 according to a fifth embodiment of the present invention.

In this embodiment, the multifunctional air pollution reduction device 1 is a surgical apparatus.

In the fifth embodiment, the multifunctional air pollution reduction device 1 includes the multifunctional pollutant remover 10 and the tool 20. The multifunctional pollutant remover 10 can be combined with the tool 20. The multifunctional pollutant remover 10 here is a removable device that can be easily attached and removed from the tool 20. The tool 20 here is an electrosurgical pencil 25 that can be used during surgery and is connected to external power through a power line 251. Air pollution is generated when using the electrosurgical pencil 25 to treat patients. The air pollution source is usually near a tip 252 of the electrosurgical pencil 25.

The multifunctional pollutant remover 10 includes the ionizer 11 and the rubber-like material part 12 that is located adjacent to the tool 20. Ions are released near the tip 111 of the ionizer 11 which is close to the source of the air pollution. The ionizer 11 can emit high concentration of positive or negative ions which can enhance the deposition of air pollutants; thus, the air pollution can be reduced. The ionizer 11 is connected to the external power through the wire 112. The detail of the ionizer 11 can be known from the contents of the aforementioned embodiments.

The rubber-like material part 12 is located at the position where the user can hold the electrosurgical pencil 25. Optionally or preferably, the rubber-like material part 12 can cover a part of or the whole electrosurgical pencil 25. The detail of the rubber-like material part 12 can be known from the contents of the aforementioned embodiments.

Thus, the fifth embodiment can be realized.

### Sixth Embodiment

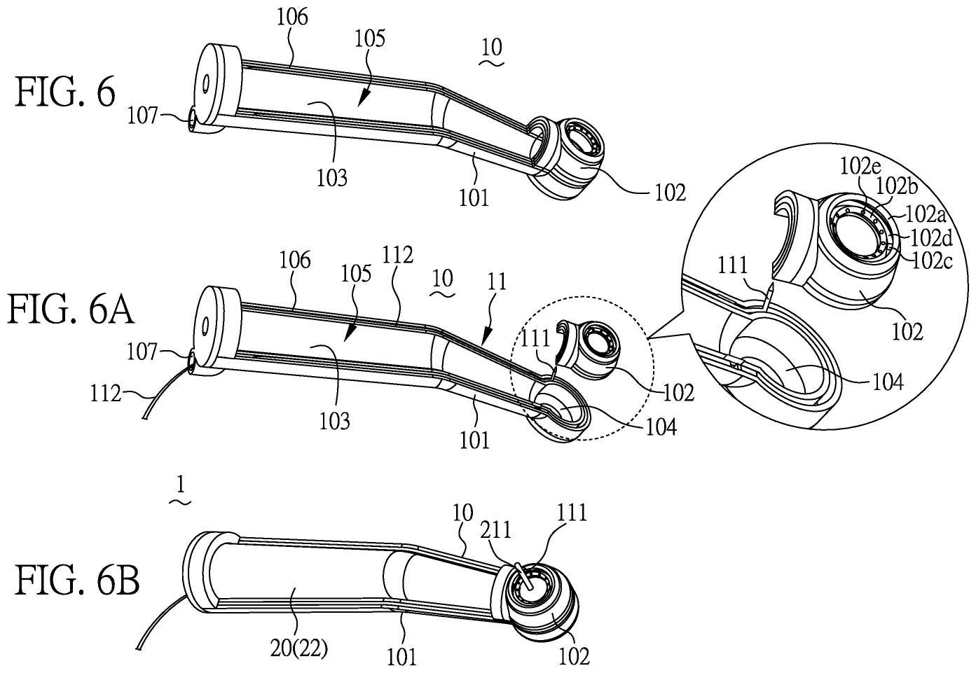

FIG. 6 is a schematic diagram illustrating the structure of a multifunctional pollutant remover according to the sixth embodiment of the present invention. FIG. 6A is another schematic diagram illustrating the structure of a multifunctional pollutant remover according to the sixth embodiment of the present invention. FIG. 6B is a schematic diagram illustrating the structure of a multifunctional air pollution reduction device according to the sixth embodiment of the present invention.

The multifunctional pollutant remover 10 can be easily attached to or removed from the tool 20, which is a dental handpiece 22 which can be used in dentistry in this embodiment.

In the embodiment, the multifunctional pollutant remover 10 includes a body part 101 and a detachable part 102, wherein the detachable part 102 is detachably assembled with the body part 101, as shown in FIG. 6. Besides, the body part 101 has a first contain part 103 and a second contain part 104, wherein the first contain part 103 is exposed through an opening 105, and the first contain part 103 and the second contain part 104 are connected together. In addition, the assembly position of the detachable part 102 corresponds to the second contain part 104, so when the detachable part 102 is separated from the body part 101, the second contain part 104 can be exposed, as shown in FIG. 6A.

In an embodiment, the shape of the first contain part 103 and the second contain part 104 correspond to the shape of the tool 20, so the user can first separate the detachable part 102 from the body part 101 and place the tool 20 in the first accommodating part 103 and the second accommodating part 104, and then assemble the detachable part 102 with the body part 101, thereby combining the tool 20 with the multifunctional pollutant remover 10, as shown in FIG. 6B. It can be understand that the structure of this embodiment can be combined easily.

In addition, a hollow airflow path 106 connected with an air inlet 107 may be provided inside the casing of the body part 101 of the multifunctional pollutant remover 10 (e.g. the space 123a in FIG. 2) for allowing airflow pass to form the air curtain near the bur 211. The hollow airflow path 106 can also be used to place the wire 112 for the ionizer 11 according to aforementioned embodiments, but not limited thereto. Besides, the outlet nozzles 124 according to the aforementioned embodiments may also be disposed inside the casings of the body part 101 and the detachable part 102 (not shown in FIGS. 6 to 6B), and the surface of the detachable portion 102 may have the holes 125, 126, 127 according to the aforementioned embodiments (not shown in FIGS. 6 to 6B), for realizing the effect according to the aforementioned embodiments (refer to FIG. 3). In another embodiment, a part of the first contain part 103 and a part of the second contain part 104 can also be used as the hollow airflow path 106, but not limited thereto.

Besides, as shown in FIGS. 6A and 6B, in an embodiment, the detachable portion 102 has an outer ring part 102a and an inner ring part 102b, wherein one or more supports 102c are connected between the outer ring part 102a and the inner ring part 102b, and spaces 102d are formed between the outer ring part 102a and the inner ring part 102b by the supports 102c. In an embodiment, the ionizer 11 is disposed in the multifunctional pollutant remover 10, wherein the wire 112 is disposed in the hollow airflow path 106, and the tip 111 is exposed from the spaces 102d.

Besides, as shown in FIG. 6A, there are a plurality of holes 102e on the inner ring part 102b. The holes 102e can be connected with the hollow airflow path 106 through the tubes, so that the holes 102e can provide the downward suppression air which has been illustrated in the aforementioned embodiments.

Besides, optionally, the outer ring part 102a, the inner ring part 102b and the body part 101 can also be integrally formed. Under this design, a part of the outer ring part 102a and a part of the inner ring part 102b can be connected with the body part 101, so that the supports 102c in aforementioned embodiments between the outer ring part 102a and the inner ring part 102b can be removed.

Thus, the sixth embodiment can be realized.

Besides, in the aforementioned embodiments, the multifunctional air pollution reduction device 1 may further include a sensor (e.g. the sensor 161 in FIG. 4 or additional sensors). The sensor is used to detect the operation of the tool 20, and sends a control signal to a control unit (e.g. the controller 162 in FIG. 4 of additional controllers) of the multifunctional pollutant remover 10 according to the operation of the tool 20, so as to turn on or turn off the multifunctional pollutant remover 10. In an embodiment, when the sensor detects that the tool 20 is in operation, the sensor sends the control signal to the multifunctional pollutant remover 10 for turning on the multifunctional pollutant remover 10. In an embodiment, when the sensor detects that the tool 20 stops operating, the sensor sends the control signal to the multifunctional pollutant remover 10 for turning off the multifunctional pollutant remover 10.

In addition, in the aforementioned embodiments, the multifunctional air pollution reduction device 1 may further include a control element (e.g. the controller 162 in FIG. 4 of additional controllers). The control chip is configured to control the ion generation rate of the ionizer 11, airflow of an airflow generator (e.g. air purifier), ROS generation rate of the photocatalytic purifier and/or the power output of the power supply, but not limited thereto. Furthermore, the control chip is configured to be controlled by a computer, a tablet, a plate panel, a smart phone, a remote controller, and/or Internet of things (IOT), but not limited thereto. Besides, in the aforementioned embodiments, the type of the tool 20 may include dental handpiece, air driven handpice, electric handpiece, ultrasonic dental scalar, ultrasonic dental scaling tips, electrosurgical pencil, polishing tool, or a tool that generates air pollution and/or noise and/or vibration while operating, but not limited thereto.

Furthermore, the features of the aforementioned embodiments can be used in combination with each other, as long as they are practicable.

Although the present invention has been explained in relation to its embodiments, it is to be understood that many other possible modifications and variations can be made without departing from the spirit and scope of the invention as hereinafter claimed.

What is claimed is:

1. A multifunctional air pollution reduction device, comprising:
a tool; and
a multifunctional pollutant remover disposed adjacent to the tool or integrated with the tool;
wherein if the multifunctional pollutant remover is disposed adjacent to the tool, the multifunctional pollutant remover is a removable device that can be attached and removed from the tool.

2. The multifunctional air pollution reduction device of claim 1, wherein air pollution is generated during an operation of the tool.

3. The multifunctional air pollution reduction device of claim 1, wherein the tool is a hand-held tool or a machine-held tool.

4. The multifunctional air pollution reduction device of claim 1, wherein the tool is a dental handpiece, an air driven handpice, an electric handpiece, an ultrasonic dental scalar, an ultrasonic dental scaling tip, an electrosurgical pencil, a polishing tool, or a tool that generates air pollution and/or noise and/or vibration while the operation.

5. The multifunctional air pollution reduction device of claim 1, wherein the multifunctional pollutant remover is an ionizer adjacent to the tool and configured to emit ions.

6. The multifunctional air pollution reduction device of claim 5, further comprising an anti-slip and/or anti-vibration surface, wherein, the anti-slip and/or anti-vibration surface fully or partially encloses the wire of the ionizer to reduce slipping, noise and/or vibration, making the handling of the tool more comfortable.

7. The multifunctional air pollution reduction device of claim 5, further comprising an active vibration control device and/or passive vibration control device.

8. The multifunctional air pollution reduction device of claim 1, wherein the multifunctional pollutant remover is connected to a vacuum pump and an air source, wherein the vacuum pump is used to extract air at a pollution source, the air source supplies air to the multifunctional pollutant remover to form an air curtain surrounding a terminal of the multifunctional pollutant remover, wherein a shape of the air curtain is cylindrical, conical or any shape helpful to confine the air pollutants within the air curtain.

9. The multifunctional air pollution reduction device of claim 8, further comprising one or more small exits to let a part of the air supplied from the air source form a downward suppression air within the air curtain, so as to help a user see the view around a bur of the tool.

10. The multifunctional air pollution reduction device of claim 8, further comprising an ionizer adjacent to the tool, wherein a release point of the ionizer is within the air curtain to help reduce the air pollution concentration within the air curtain.

11. The multifunctional air pollution reduction device of claim 8, further comprising an ionizer adjacent to the tool, wherein the ionizer releases ions inside and/or outside the air curtain.

12. The multifunctional air pollution reduction device of claim 8, wherein the component of the air supplied from the air source comprises:
(i) particle-free air; or
(ii) compressed air; or
(iii) positive or negative ions; or
(iv) reactive oxygen species; or
(v) gas; or
(vi) particles; or
(vii) water vapor; or
(vii) any combination above.

13. The multifunctional air pollution reduction device of claim 8, further comprising an anti-slip and/or anti-vibration surface, wherein the anti-slip and/or anti-vibration surface fully or partially encloses the wire of the ionizer.

14. The multifunctional air pollution reduction device of claim 1, wherein the multifunctional pollutant remover is within the tool and connected to an air source, the air source supplies air to the multifunctional pollutant remover to form an air curtain surrounding a terminal of the multifunctional pollutant remover, wherein a shape of the air curtain is cylindrical, conical or any shape to help confine the air pollutants.

15. The multifunctional air pollution reduction device of claim 1, further comprising an active vibration control device and/or passive vibration control device located inside or outside the tool.

16. The multifunctional air pollution reduction device of claim 1, further comprising a charged deposition surface, wherein the charged deposition surface is placed under the multifunctional pollutant remover.

17. The multifunctional air pollution reduction device of claim 1, further comprising a power supply connected to the multifunctional pollutant remover and/or the tool.

18. The multifunctional air pollution reduction device of claim 1, further comprising a sensor configured to detect an operation of the tool and send a control signal to turn on the multifunctional air pollution reduction device.

19. The multifunctional air pollution reduction device of claim 1, further comprising a control unit configured to control an ion generation rate of an ionizer, an airflow of an airflow generator, an ROS generation rate of a photocatalytic purifier, and/or a power output of a power supply.

20. The multifunctional air pollution reduction device of claim 19, wherein the control unit is controlled by a computer, a tablet, a plate panel, a smart phone, a remote controller, and/or Internet of things (IOT).
